(19) United States
(12) Patent Application Publication
(10) Pub. No.: US 2003/0025981 A1
(43) Pub. Date: Feb. 6, 2003

(54) Micromachined optical phase shift device

(75) Inventors: Akira Ishikawa, Royse City, TX (US); Takashi Kanatake, Dallas, TX (US); Wenhui Mei, Plano, TX (US); Wade P. Farrow, Dallas, TX (US); Chad Mueller, Wylie, TX (US); Phillip Ahrens, Dallas, TX (US); Zhiqiang Feng, Nagareyama-Shi (JP); Kin Chan, Plano, TX (US)

Correspondence Address: HAYNES AND BOONE, LLP, 901 MAIN STREET, SUITE 3100, DALLAS, TX, 75202, US

(73) Assignee: Ball Semiconductor, Inc., Allen, TX

(21) Appl. No.: 09/918,732

(22) Filed: Jul. 31, 2001

(51) Int. Cl. G02F 1/03; G02F 1/07; G02B 26/00

(52) U.S. Cl. 359/290; 359/291; 359/292

(57) ABSTRACT

An apparatus and method for adjustably reflecting light is provided. The apparatus includes a base and, positioned above the base, a member having an upper surface and a lower surface. A reflective coating is applied to at least a portion of the upper surface. The system also includes a capacitive plate positioned between the member and the base. The capacitive plate is operable to deflect the member, which alters the orientation of the member relative to the base. A second member, which may be deformable, may be attached to the first member so that deformation of the second member alters the orientation of the first member relative to the base.

The deflection of the surface enables the apparatus shift the phase of the reflected light, as well as to change the angle of the reflected light. In addition, the apparatus may be used in applications such as digital projection, optical-optical switching, Fabry-Perot interferometry, and phase shifting based inferometry.

### BACKGROUND

The present invention relates generally to optical systems, and more particularly, to an optical phase shift device.

In recent years, a number of micro optical electrical mechanical system (MOEMS) devices have been constructed. Some of these reflect light using actuated micromirrors and are operable to change the angle of the reflected light by changing the mirror angle. Such devices are used in optical-optical switching for the communications industry. Other devices, such as the Texas Instrument's digital mirror device or DLP, change the mirror angle and hence the path of the reflected light. However, the devices discussed above are generally not operable to do more than reflect light at different angles.

Other devices may be used to shift the phase of light. For example, U.S. Pat. No. 5,969,848 describes a phase shift device which operates by vertically actuating a micromirror by means of an electrostatic comb drive. However, this patent requires using additional space surrounding the micromirror for the silicon pads and fingers necessary to levitate the micromirror. This prevents multiple micromirrors from being positioned in close proximity. In addition, the patent does not enable the micromirror's surface orientation relative to the base to be flexibly altered, and so limits the possible angle and phase of the reflected light.

Therefore, certain improvements are needed for a MOEMS device. For example, it is desirable to achieve phase shifting and light redirection. It is also desirable to position the entire actuating portion directly under the micromachined mirror, so that a two dimensional array of the device can be achieved on a single substrate. This allows the mirrors to be placed in very close proximity and results in a higher resolution of the phase shifted light. For applications such as lithography, it is desirable to adjust for irregularities present on surfaces. It is also desirable to provide high light energy efficiency, to provide high productivity and resolution, and to be more flexible and reliable.

### SUMMARY

A technical advance is provided by a novel method and apparatus for adjustably reflecting light. The apparatus includes a base and, positioned above the base, a member having an upper surface and a lower surface. A reflective coating is applied to at least a portion of the upper surface. The apparatus also includes a capacitive plate positioned between the member and the base. The capacitive plate is operable to deflect the member, which alters the orientation of the member relative to the base.

In another embodiment, the apparatus includes a second member positioned between the first member and the capacitive plate, the second member including an upper surface and a lower surface. The apparatus also includes a stalk positioned between and connecting the first and second members. The capacitive plate is operable to deflect the second member, the deflection altering the orientation of the first member relative to the base.

In yet another embodiment, at least one surface of the second member includes a conductive coating. In still another embodiment, the second member is deformable. The capacitive plate is operable to deform the second member, which alters the orientation of the first member relative to the base.

### BRIEF DESCRIPTION OF THE DRAWINGS

FIG. 1 is a diagrammatic view of an improved digital photolithography system for implementing various embodiments of the present invention.

FIG. 2 is a diagrammatic view illustrating a portion of the digital photolithography system of FIG. 1 utilizing a phase shift device.

FIG. 3 is a diagrammatic view illustrating the portion of the digital photolithography system of FIG. 2 utilizing a wavefront sensor.

FIG. 4 illustrates one embodiment of the phase shift device of FIG. 2.

FIG. 5 illustrates a top view of an exemplary reflective surface of the phase shift device of FIG. 4 utilizing square mirrors.

FIG. 6 illustrates a top view of an exemplary reflective surface of the phase shift device of FIG. 4 utilizing hexagonal mirrors.

FIG. 7 illustrates the phase shift device of FIG. 4 with deflected membranes.

FIG. 8 illustrates four capacitive plates underlying each membranes in another view of the phase shift device of FIG. 4

FIG. 9 illustrates another embodiment of the phase shift device of FIG. 2 utilizing sets of adjacent capacitive plates.

FIG. 10 illustrates an enlarged view of a portion of the phase shift device of FIG. 9.

FIG. 11 illustrates another embodiment of the phase shift device of FIG. 9 utilizing a different placement of the capacitive plates.

FIG. 12 illustrates another embodiment of the phase shift device of FIG. 2 utilizing bars to suspend a mirror, a stalk, and an upper capacitive plate.

FIG. 13 illustrates another embodiment of the phase shift device of FIG. 2, where the device utilizes stalks to control vertical movement.

FIG. 14 illustrates the phase shift device of FIG. 13 after removal of a sacrificial layer.

FIG. 15 illustrates a side view of the phase shift device of FIG. 13.

FIG. 16 illustrates a top view of the phase shift device of FIG. 13.

FIG. 17 illustrates an embodiment of the phase shift device of FIG. 2 utilizing a shell.

FIG. 18 illustrates the phase shift device of FIG. 17 after removal of a sacrificial layer.

### DETAILED DESCRIPTION

The present disclosure relates to optical devices and more particularly to micromachined optical phase shift devices, such as can be used in semiconductor photolithographic processing. It is understood, however, that the following disclosure provides many different embodiments, or examples, for implementing different features of the invention. Specific examples of components and arrangements are described below to simplify the present disclosure. These are, of course, merely examples and are not intended to limit the invention from that described in the claims. In addition, the present disclosure may repeat reference numerals and/or letters in the various examples. This repetition is for the purpose of simplicity and clarity and does not in itself dictate a relationship between the various embodiments and/or configurations discussed.

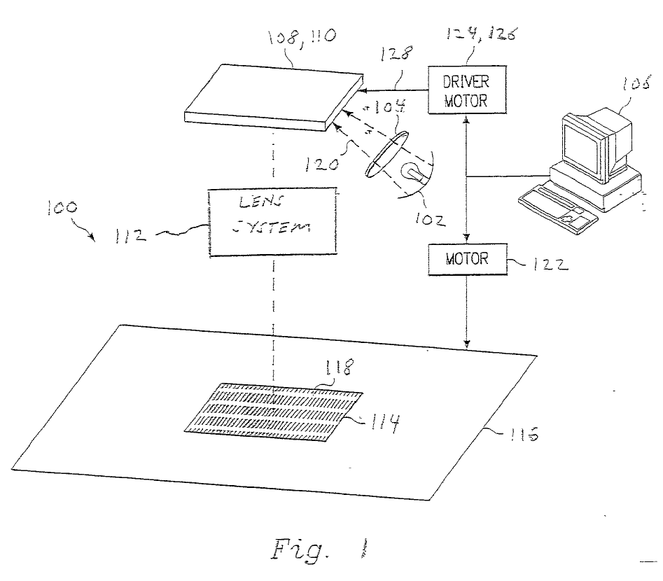

Referring now to FIG. 1, a maskless photolithography system 100 is one example of a system that can benefit from the present invention. In the present example, the maskless photolithography system 100 includes a light source 102, a first lens system 104, a computer aided pattern design system 106, a pixel panel 108, a panel alignment stage 110, a second lens system 112, a subject 114, and a subject stage 116. A resist layer or coating 118 may be disposed on the subject 114. The light source 102 may be an incoherent light source (e.g., a Mercury lamp) that provides a collimated beam of light 120 which is projected through the first lens system 104 and onto the pixel panel 108.

The pixel panel 108 is provided with digital data via suitable signal line(s) 128 from the computer aided pattern design system 106 to create a desired pixel pattern (the pixel-mask pattern). The pixel-mask pattern may be available and resident at the pixel panel 108 for a desired, specific duration. Light emanating from (or through) the pixel-mask pattern of the pixel panel 108 then passes through the second lens system 112 and onto the subject 114. In this manner, the pixel-mask pattern is projected onto the resist coating 118 of the subject 114.

The computer aided mask design system 106 can be used for the creation of the digital data for the pixel-mask pattern. The computer aided pattern design system 106 may include computer aided design (CAD) software similar to that which is currently used for the creation of mask data for use in the manufacture of a conventional printed mask. Any modifications and/or changes required in the pixel-mask pattern can be made using the computer aided pattern design system 106. Therefore, any given pixel-mask pattern can be changed, as needed, almost instantly with the use of an appropriate instruction from the computer aided pattern design system 106. The computer aided mask design system 106 can also be used for adjusting a scale of the image or for correcting image distortion.

In some embodiments, the computer aided mask design system 106 is connected to a first motor 122 for moving the stage 116, and a driver 124 for providing digital data to the pixel panel 108. In some embodiments, an additional motor 126 may be included for moving the pixel panel. The system 106 can thereby control the data provided to the pixel panel 108 in conjunction with the relative movement between the pixel panel 108 and the subject 114.

As is discussed below in greater detail, the second lens system 112 may include a phase shift device comprising an array of micromirrors which are vertically actuated by parallel capacitive plates to achieve phase shifting of light reflected off the micromirrors. In addition, multiple capacitive plates may be used to enable beam deflection or vertical actuation.

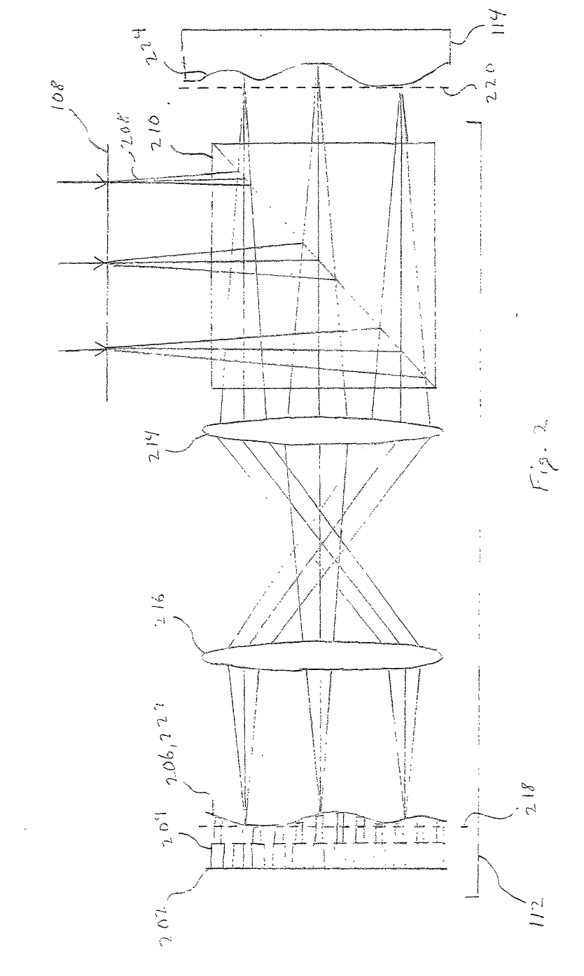

Referring now to FIG. 2, in one embodiment, the second lens system 112 of FIG. 1 includes a phase shift device 202 to adjust the projection of light onto a subject 114. The phase shift device 202, which is discussed later in greater detail, is operable to project light in such a way as to account for surface irregularities on the subject 114. The phase shift device 202 includes a plurality of actuators 204 which control the displacement of a surface 206. In the present embodiment, the surface 206 is reflective and so operable as a mirror.

In operation, light 208 is reflected from a pixel panel 108 and into a beam splitter 210. The beam splitter 210 is operable to reflect a portion of the light and allow a portion of the light to pass through. The portion of the light reflected by the beam splitter 204 enters a lens 214. The light passes from the lens 214 into a lens 216, which projects the light onto the phase shift device 202.

The mirror 206 of the phase shift device 202 may initially be at a neutral position, which is defined for purposes of illustration to correspond to an image plane 218. The light is reflected from the mirror 206 through the lenses 216, 214 and into the beam splitter 210. The beam splitter 210 passes a portion of the light through in the direction of the subject 114. The light which passes through the beam splitter 210 is focused on an image plane 220 as follows.

The lenses 214, 216 will ordinarily focus an image located at the image plane 218 onto the image plane 220, assuming the lenses remain in a constant location. Moving the image plane 218 closer to the lenses will move the location of the image plane 220 away from the lenses. Moving the image plane 218 away from the lenses will move the location of the image plane 220 closer to the lenses. Therefore, the distance of the image plane 218 from the lenses determines the distance of the image plane 220 from the lenses.

If the focal length of the lens system formed by lenses 214, 216 remains constant, then displacing a portion of the image plane 218 will move the corresponding portion of the image plane 220 the same distance. Likewise, by displacing multiple portions of the image plane 218 by different amounts, each corresponding portion of the image plane 220 will be similarly displaced. Therefore, by controlling portions of the image plane 218, the location of various portions of the image plane 220 can be controlled.

The actuators 204 of the phase shift device 202 are operable to displace the mirror 206 so as to displace the original image plane 218 to a displaced image plane 222. By controlling the displacement of the mirror 206, the phase of portions of the light may be altered in a controllable manner. The light, after being reflected by the displaced mirror 206 of the phase shift device 202, is focused on a displaced image plane 224 instead of the original image plane 220. The displaced image plane 224 is similar to the image plane 222 formed by the mirror 206. The amount of similarity may depend on the resolution of the lens system, the properties of the beam splitter, and similar issues. In this manner, the image projected by the pixel panel 108 may be distorted in a controllable manner and projected onto the subject 114.

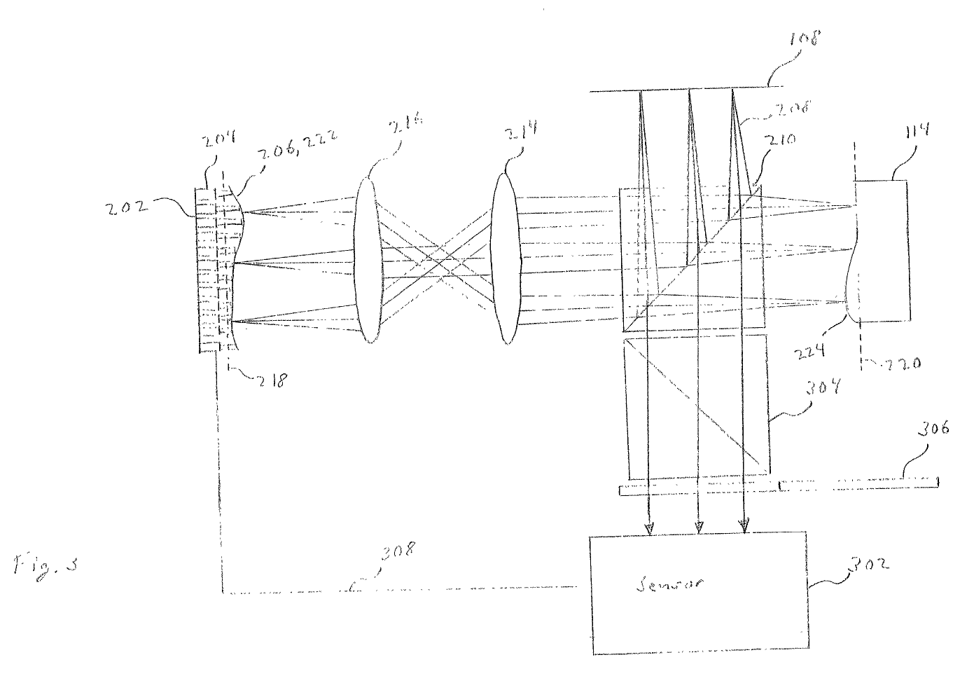

Referring now to FIG. 3, the lens system 112 of FIG. 2 is illustrated with the addition of a sensor 302, which in the present embodiment is a Shack-Hartmann wavefront sensor, to correct for surface irregularities in the subject 114. The sensor 302 may detect irregularities in the nanometer range on the surface of the subject 114 by receiving a wavefront which embodies the surface of the subject 114. The wavefront may then be analyzed to determine information such as the location and magnitude of irregularities. The resulting wavefront analysis information may be used to adjust the displacement of the mirror 206 of the phase shift device 202 so as to account for the irregularities.

In operation, as in FIG. 2, light 208 travels from the pixel panel 108 into the beam splitter 210. A portion of the light 208 is reflected by the beam splitter 204 into the lens 214. Another portion of the light 208 passes through the beam splitter 204. The light passes from the lens 214 into the lens 216, which projects the light onto the phase shift device 202.

As in FIG. 2, the mirror 206 of the phase shift device 202 may ordinarily be at a neutral position, which is defined for purposes of illustration to correspond to an image plane 218. The light is reflected from the mirror 206 through the lenses 216, 214 and into the beam splitter 210. The beam splitter 210 passes a portion of the light through in the direction of the subject 114. If the mirror 206 is in the neutral position (forming the image plane 118), the light will be focused on a similar image plane 220 on the subject 114. If irregularities exist on the surface of the subject 114, the light will not be properly focused at those points. Assuming that the surface of the subject does not conform to the image plane 220, the light which is reflected by the subject 114 will be reflected from an image plane 224 which is formed by the surface of the subject 114. The light will be reflected back into the beamsplitter 210, which in turn reflects a portion of the light into a second beamsplitter 304. A portion of the light passes through the beamsplitter 304 and into a filter 306, such as a rotating filter. Light exiting from the rotating filter 306 enters the sensor 302.

The sensor 302 is operable to detect the light reflected from the surface of the subject 114 as wavefront information, which is passed to a computer system (not shown). The computer system may analyze the information to identify irregularities, calculate the magnitude and/or location of the irregularities, and perform similar operations. In addition, the computer system may be connected to the phase shift device 202 by one or more signal lines 308. The computer system utilizes the information obtained about surface irregularities of the subject 114 to send signals to the phase shift device 202. The signals serve to control the actuators 204 and the displacement of the mirror 206 (and, therefore, form a new image plane 222) in such a way as to make corrections for the irregularities on the surface of the subject 114.

Following this displacement of the mirror 206, the light projected from the pixel panel 108, off the beam splitter 210, and through the lenses 214, 216 will reflect from the image plane 222 formed by the displaced mirror 206, rather than the original image plane 218. The light will be reflected through the lenses 216, 214 and the beam splitter 210. The reflected light, which includes phase shifted light caused by the displacement of the mirror 206, will be properly focused onto the image plane 224 formed by the surface of the subject 114.

Therefore, the mirror 206 is deformed by the actuators 204 in such a manner as to “mirror” the deformations on the surface of the subject 114 and thus cause the light projected onto the surface to be uniformly in focus. Further refinements of the image plane 224 may occur by repeating the operation through the sensor 302 and correcting the image plane 222 formed by the mirror 206. It is noted that the lens system may act as a multiplier for the measured substrate surface irregularities, thus allowing very small changes of position of the mirror 206 to be optically magnified to adjust for larger subject surface defects.

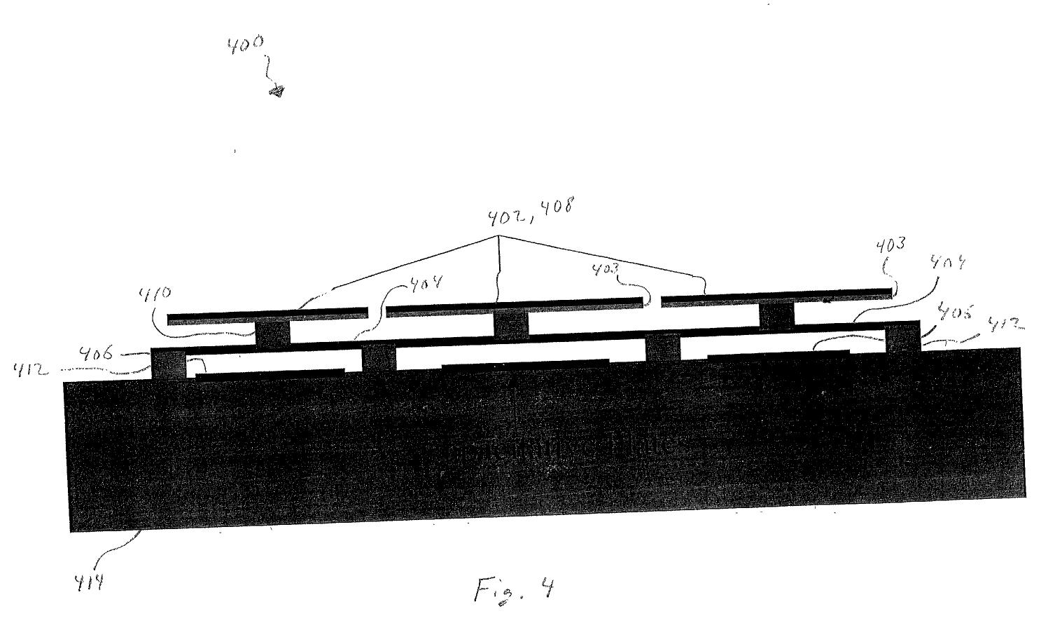

Referring now to FIG. 4, a cross section of one embodiment of an exemplary phase shift device 400 includes a coating 402, an upper member 403, a lower member 404, and capacitive plates 406 on a base 414. The coating 402 may include a reflective compound or mirrors 408 so that the coating 402 is reflective. For example, the mirrors 408 may be an aluminum mirror coating achieved by ion deposition, which is known in the art. In the present embodiment, the upper member 403 is rigid, while the lower member 404 is deformable. The base 414 may be a substrate fabricated through a layer deposition process or may be constructed using other techniques. In the present embodiment, the phase shift device 400 is constructed so that the deformable member 404, plates 406, and other components for each corresponding rigid member 403 are primarily located beneath the rigid member 403.

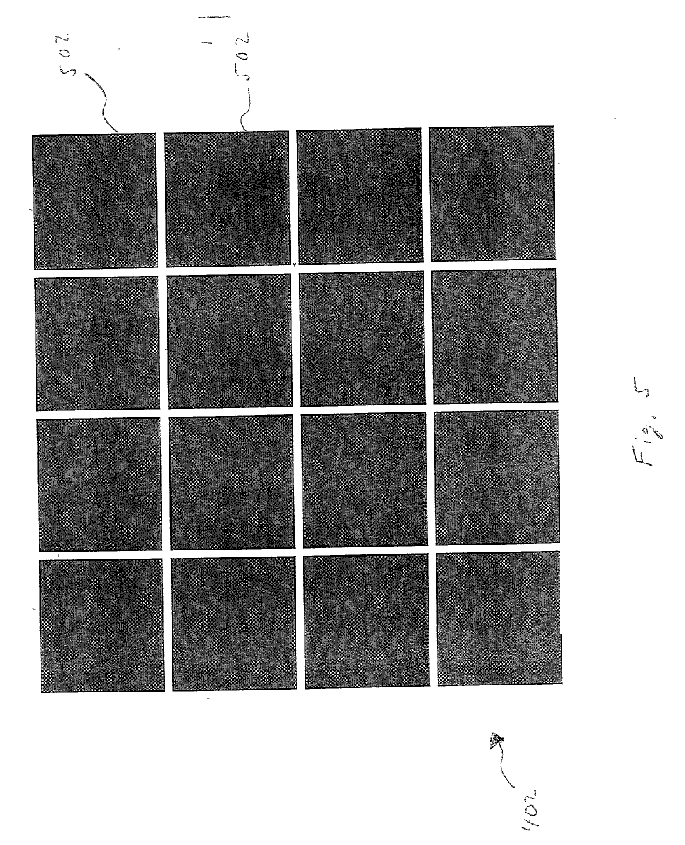

Referring now to FIG. 5, a top down view of one embodiment of the reflective coating 402 on a plurality of rigid members 403 of FIG. 4 illustrates forming a plurality of square mirrors 502 with the coating 402 which is applied to the rigid members 403. The mirrors 502 may be spaced so as to achieve a desired reflective surface. The mirrors 502 may be microns in size and it is appreciated that the exact size of the mirror depends on the embodiment and particulars of design. For example, the mirrors 502 may each be from 5×5 to 20×20 microns.

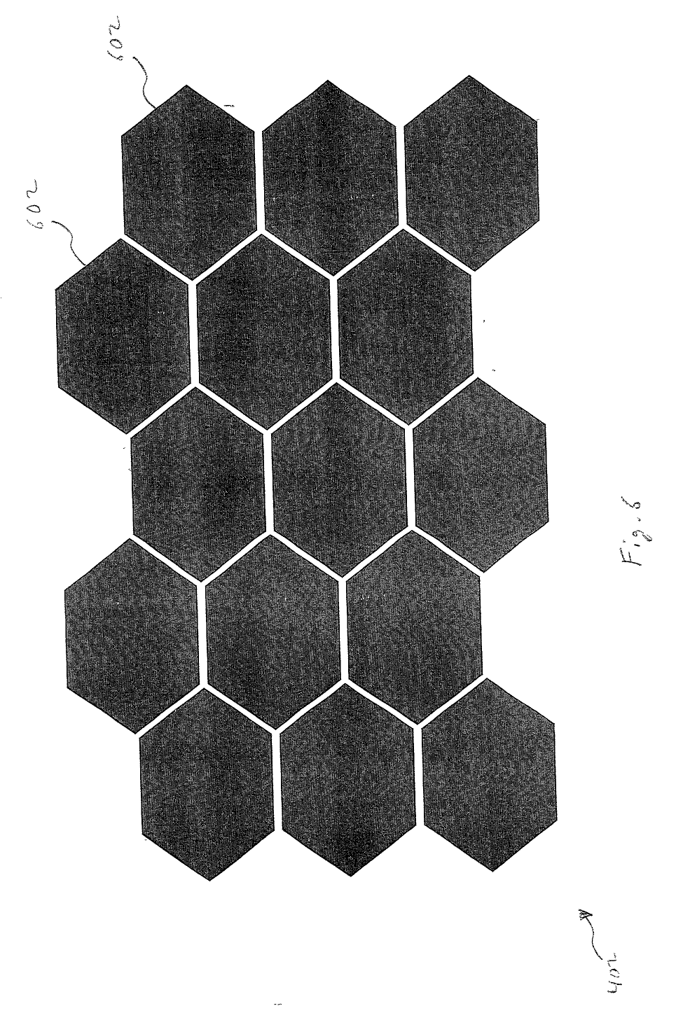

Referring now to FIG. 6, another embodiment of the reflective coating 402 on the rigid members 403 of FIG. 4 utilizes a plurality of hexagonal mirrors 602. As with the mirrors 502 of FIG. 5, the mirrors 602 may be sized and spaced as desired. Other shapes of mirrors are also contemplated by the present invention, and may be of different sizes and spacing.

Referring again to FIG. 4, the deformable member 404 may be a deformable membrane, such as a nitride membrane, which may be relatively thin so as to be deformed more easily. In addition, the membrane 404 may have a metallic coating, such as an aluminized coating, which makes the membrane 404 conductive. The mirrors 408 are positioned on the rigid members 403, which are positioned above and connected to the membranes 404 on stalks 410. The membranes 404 are themselves positioned on supports 412. The supports 412 raise the membranes 404 above the capacitive plates 406. It is noted that the membranes 404 may be a single membrane or may be multiple membranes. For purposes of illustration, the membranes 404 will be described as a plurality of circular membranes, each with a stalk 410 attached to its center and supported from below by supports 412. It is also noted that each of the supports 412 may be a single cylindrical support with a hollow interior, so that each circular membrane 404 is fully supported around the edge, or the supports 412 may be formed by one or more shapes suitable for supporting the membrane 404. Located below each of the membranes 404 are four capacitive plates 406.

In operation, activation of one or more of the capacitive plates 406 deflects the conductive aluminized coating of the membrane 404. The degree of deflection may be controlled by varying which capacitive plates 406 are activated and the degree of activation. Increasing the number of capacitive plates 406 may increase the amount of control with which the membrane 404 may be deflected.

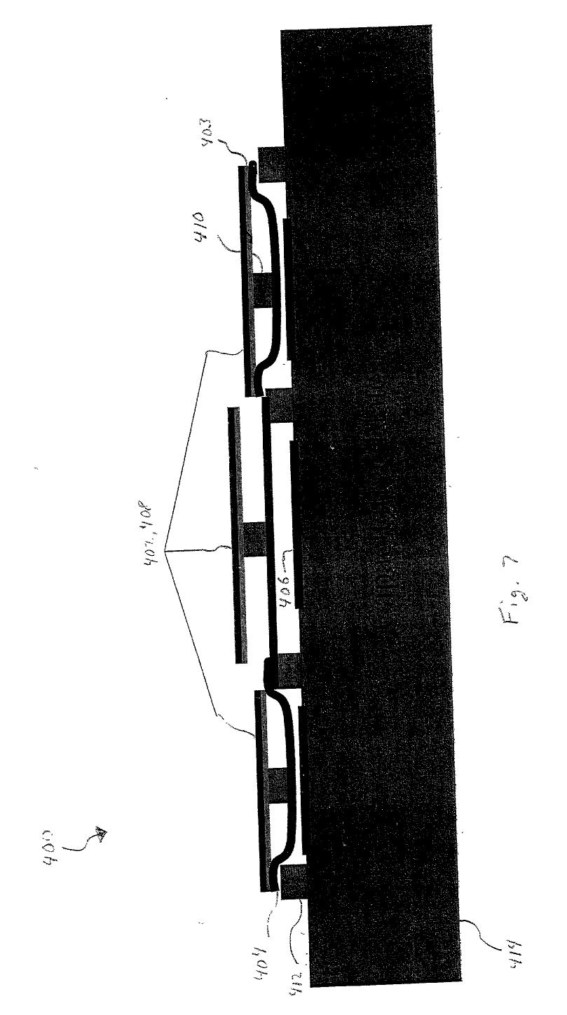

Referring now to FIG. 7, the phase shift device 400 of FIG. 4 is illustrated with two of the three membranes 404 deflected downward. As described above, this deflection results in a corresponding downward deflection of the associated mirrors. The magnitude of the deflection may vary, depending on the desired result. For example, the deflection may be less than a fourth of the wavelength of the light, and so serve to shift the phase of the reflected light.

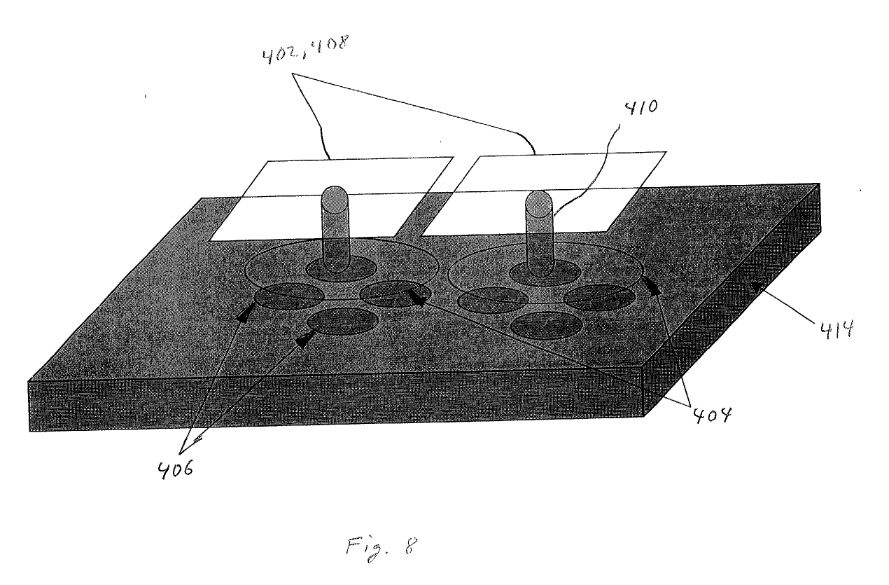

Referring now to FIG. 8, an angular view of the phase shifting device 400 of FIG. 4 illustrates the base 414 with two of the mirrors 408 and their corresponding stalks 410, membranes 404, and capacitive plates 406. Supports 412 are not shown so as to clarify the present embodiment. Each membrane 404 may be larger than the area encompassing the four capacitive plates 406 located beneath the membrane 404. Each stalk 410 attached to the center of the corresponding membrane 404 is sized such that total deflection (caused by the activation of all four capacitive plates) or lack thereof (i.e., none of the capacitive plates are activated) maintains the surface of the corresponding mirror 408 substantially parallel to the base 414. However, the activation of one, two, or three of the four capacitive plates 406 causes asymmetric deflection of the membrane 404. This asymmetric deflection alters the parallel orientation of the mirror 408 with respect to the base 414 and so enables the mirror 408 to “tilt.” This asymmetrical deflection may be used to alter the direction of light reflected from the mirror 408.

One method for the manufacture of the embodiment of the phase shift device 400 as described above and illustrated in FIGS. 4-8 may be accomplished as follows. Copper capacitive plates 406 are formed upon a silicon substrate base 414 by chemical vapor deposition, although other metals such as aluminum may be used. A membrane 404 is preferably formed from nitride for a variety of reasons. Nitride is a strong material, nitride deposition allows precise control of the stress in the nitride layer, and the nitride surface layer is not damaged by etching when selective etchants are used. Nitride may also serve as an insulator to prevent shorting between the capacitive plates 406. Etching of the nitride membrane 404 may be accomplished using anisotropic etching techniques such as water/KOH. This may result in a selective process with a high degree of preservation, although etching is done with a square or rectangular aperture. Circular apertures may be approximated by utilizing special compensation masks.

An insulating layer is deposited on a silicon substrate. This is followed by deposition of a sacrificial silicon dioxide film and then a silicon nitride film, both approximately 200 nanometers thick. To create a low-stress silicon nitride film, extra silicon is added to the stochiometric balance, reducing the tensile stress of the resulting silicon nitride film.

Upon these layers, which make up the capacitive actuator portion (including the membrane 404) of the present embodiment, a silicon stalk 410 is attached with a surrounding silicon dioxide sacrificial layer. A silicon substrate is deposited on top with dimensions equal to the final micromachined mirror size, which as previously stated may be from 5×5 to 20×20 microns. A thin aluminum coating is sputtered upon the substrate to act as a mirror 408. The sacrificial layers may then be etched, leaving the embodiment illustrated in FIGS. 4-8.

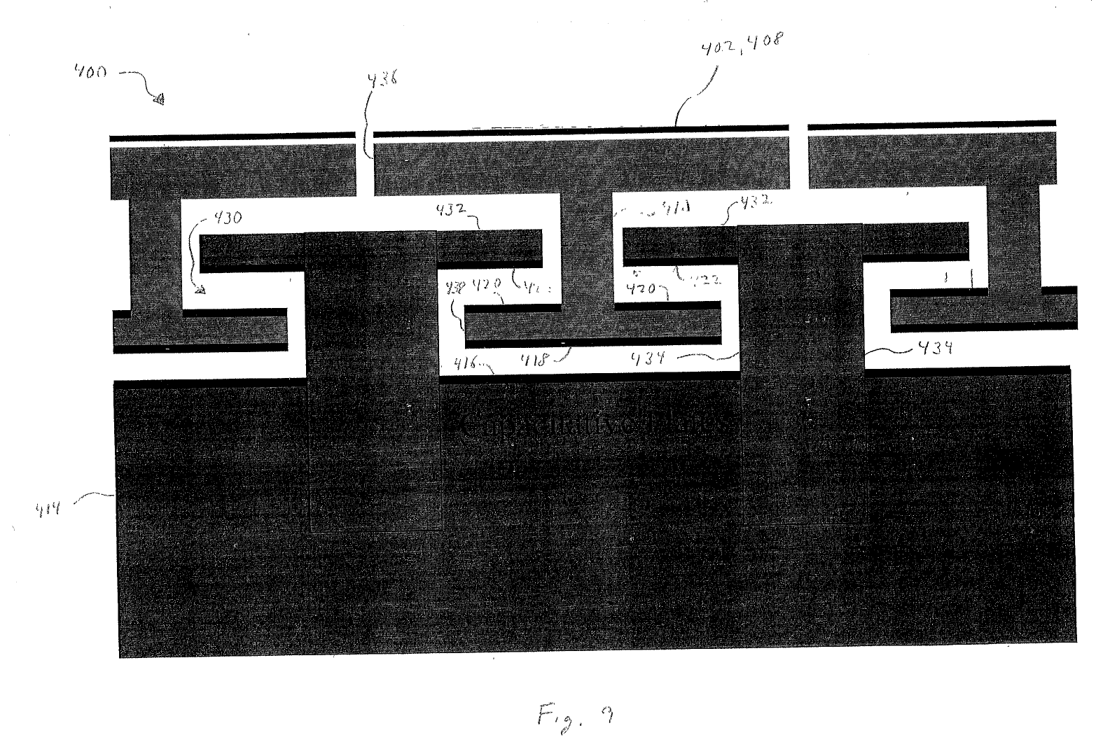

Referring now to FIGS. 9 and 10, in another embodiment of the present invention, a mirror 408 is supported by an upper member 436 (not shown in FIG. 10). Alternatively, the upper member 436 may be formed entirely by the mirror 408. The upper member 436 is attached to a lower member 438 by a stalk 410. The mirror 408, stalk 410, and members 436, 438 may be manufactured by layer deposition, as may a plurality of capacitive plates 416-422. In the present embodiment, there are four capacitive plates 416-422 for each mirror 408.

The lower member 438 is positioned in a cavity 430 in a base 414, and is retained within the cavity 430 by a cylindrical wall 434 and a lip 432. In the present embodiment, the cavity 430 is cylindrical in structure and the lip 432 continues around the entire edge of the cavity 430. In other embodiments, the cavity 430 may be structured differently, and the lip 432 may or may not be continuous. The capacitive plates 416-422 are positioned as follows. The plate 416 is positioned at the bottom of the cavity 430, while the plate 422 is positioned on the lower surface of the lip 432. The plates 418, 420 are positioned on the lower and upper surfaces, respectively, of the lower member 438. It is noted that the capacitive plates 416-422 are single, continuous plates in the present embodiment, but may be segmented if so desired.

In operation, the plate 416 and the plate 418 may interact through charge repulsion, as may the plates 420, 422. The charge repulsion caused by activation of the plates 416, 418 enables vertical actuation of the lower member 438. This vertical movement results in vertical actuation of the stalk 410 and the corresponding upper member 436 and mirror 408, allowing deflection of the mirror 408. The charge repulsion between the plates 420, 422 similarly results in vertical actuation, which may be used to offset the vertical movement caused by the plates 416, 418 and enable more precise control. The degree of vertical actuation may be sensed and controlled by varying the voltage of the plates 416, 418 and 420, 422. This enables the device to be actuated in any direction in three dimensional space, regardless of the effects of gravity.

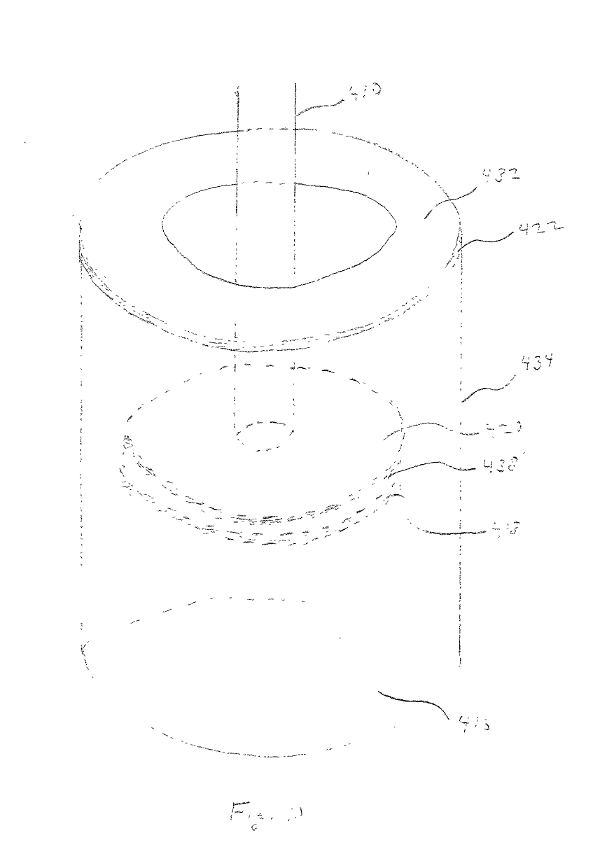

Referring now to FIG. 11, another embodiment of the phase shift device 400 is illustrated. In the present embodiment, which is similar to that illustrated in FIGS. 9 and 10, the capacitive plates 416, 418 have been positioned on the upper surface of the lip 432 and the lower surface of the upper member 436, respectively. The plates 416, 418 and 420, 422 are operable to vertically actuate the mirror 408 through charge repulsion. As in FIGS. 9 and 10, the plates 416, 418 and the plates 420, 422 may be used in combination to sense and control the position of the mirror 408.

It is understood that placing the capacitive plates 416-422 in other locations may achieve a similar result. For example, the plates 416-422 may be placed on the bottom of the cavity 430, the lower surface of the lower member 438, the upper surface of the lip 432, and the lower surface of the upper member 436, respectively. Fewer or more capacitive plates may also be used.

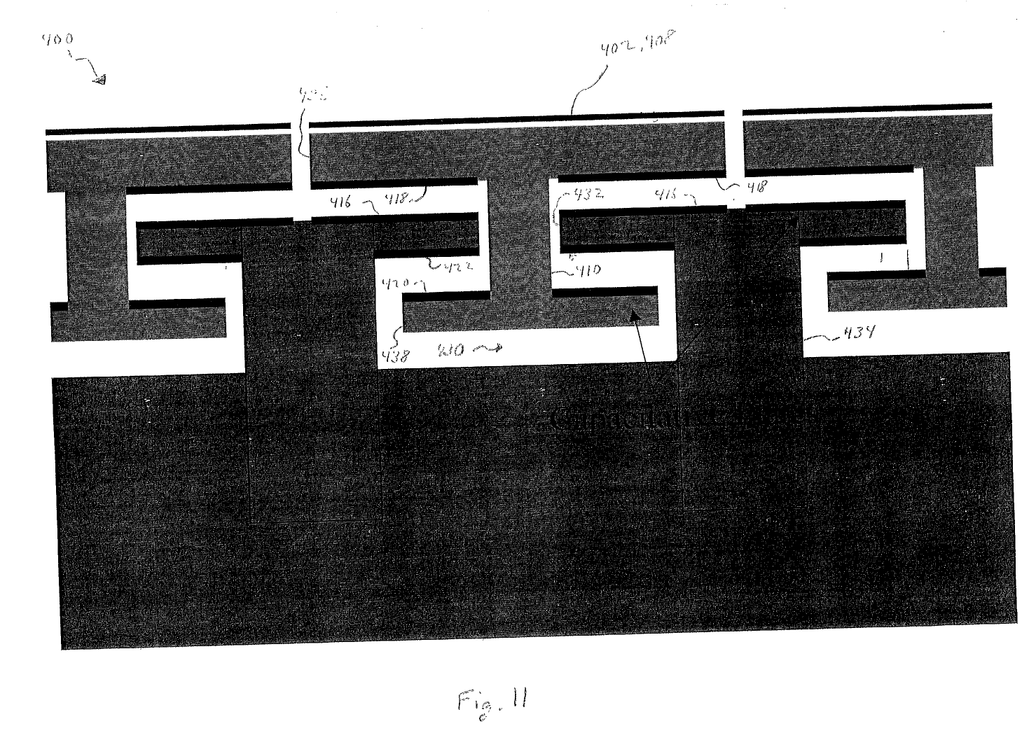

Referring now to FIG. 12, in another embodiment of the phase shift device 400, two capacitive plates 416, 418 are utilized to control the movement of a mirror 408. In the present embodiment, the mirror 408 is attached by a stalk 410 to a capacitive plate 418. The stalk 410 is attached to a support 412 by two arms 440. The arms 440 in the present embodiment are flexible and so allow vertical movement of the stalk 410 and associated mirror 408 and plate 418. The support 412 is attached to a base 414. Also attached to the base 414 is a capacitive plate 416. It is noted that the support 412, plate 416 and base 414, along with other components, may be fastened together or may be fabricated as a single piece.

The arms 440 may be micromachined silicon torsion bars which are designed to hold the mirror 408 parallel to the surface of the base 414. The design of the bars 440 may be such that vertical deflection is achievable without allowing angular torsion of the mirror surface. The manufacture of such torsion bars 440 is known in the art and can be achieved using anisotropic etching. The width, height, and length of the bars 440 may vary according to the mass of the mirror 408, stalk 410, and plate 418. It is appreciated that several ratios of mass with several designs may be implemented, as may designs with more or less bars 440.

In operation, the capacitive plates 416, 418 may be utilized to control the degree of vertical actuation through charge repulsion. The degree of repulsion between the plates 416, 418 may be controlled by varying the voltage supplied to the plates 416, 418. As the distance between the plates 416, 418 is altered, the position of the mirror 408 with respect to the base 414 is also altered.

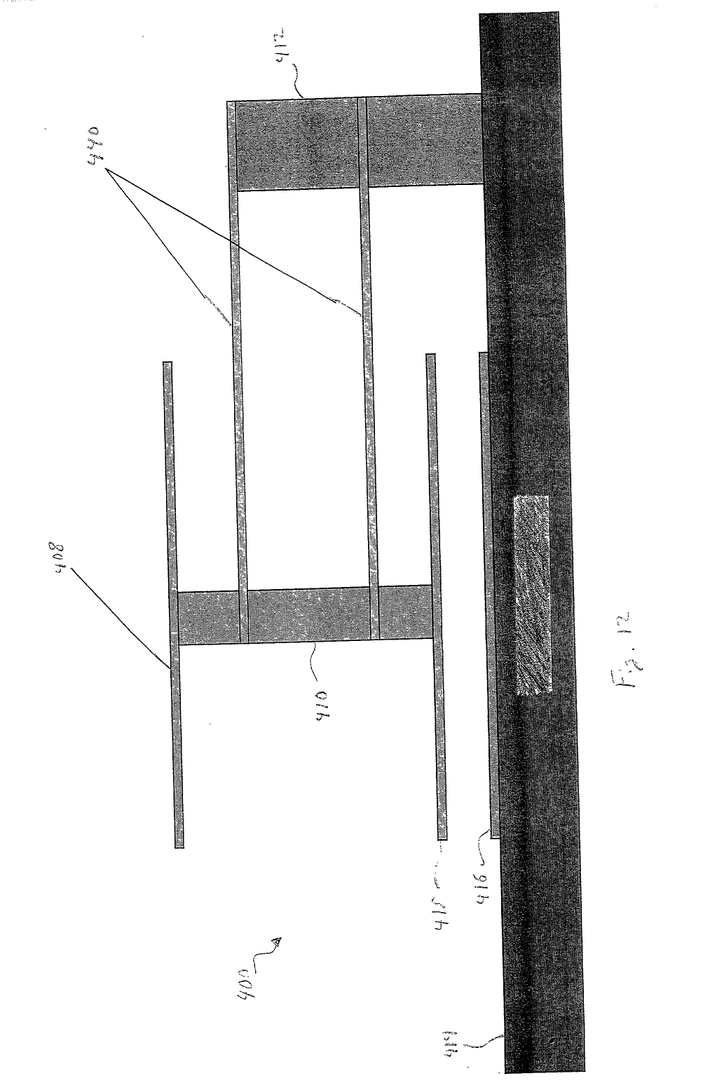

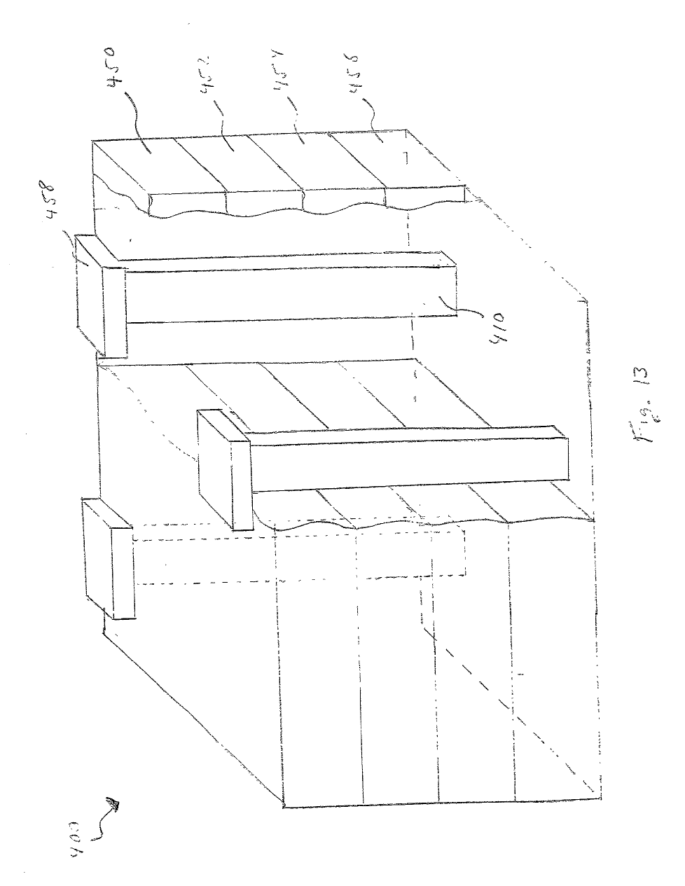

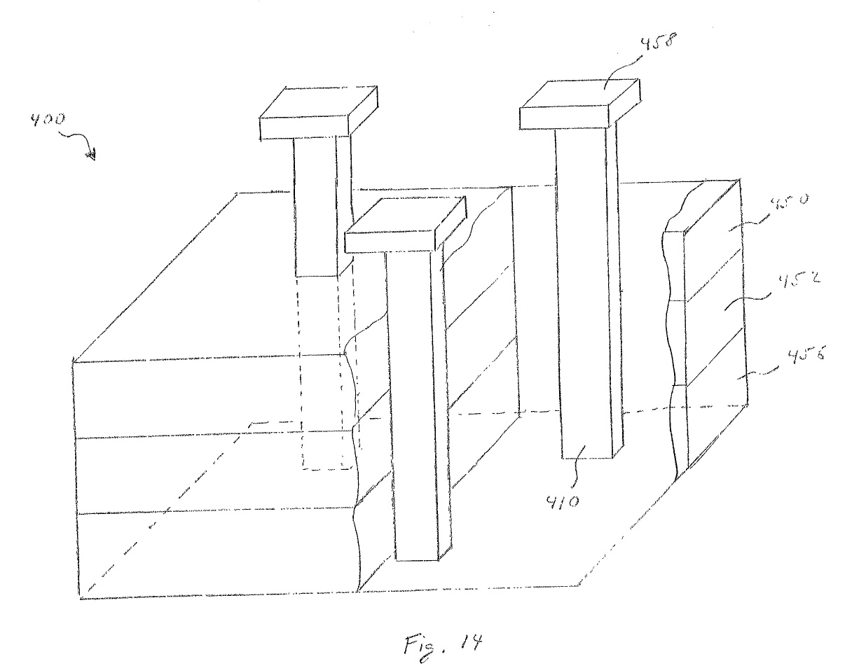

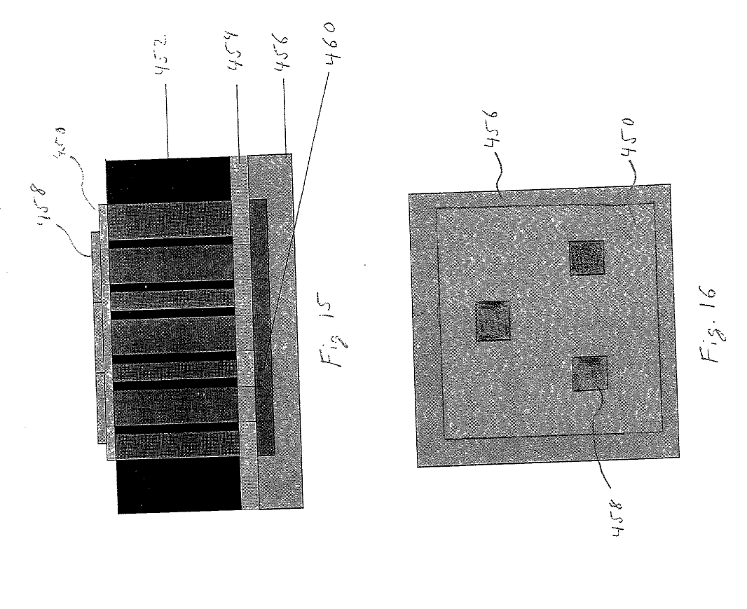

Referring now to FIGS. 13-16, in yet another embodiment, the phase shift device 400 includes a mirror 450, a mirror base 452, and a substrate 456. The mirror 450, mirror base 452 and substrate 454 are positioned in descending layers, with the mirror 450 being the top layer and the substrate 456 being the bottom layer. During fabrication, as illustrated in FIG. 13, a sacrificial layer 454 is also included in the phase shift device 400 between the mirror base 452 and the substrate 456. Positioned within the layers are three silicon stalks 410 which act as guides to the mirror 450 and mirror base 452. The stalks may be attached to the substrate 456 or, alternatively, may be constructed as part of the substrate 456. Each stalk 410 includes a cap 442 which is larger in cross-sectional area than the corresponding stalk 410. The cap 442 is located above the mirror 450 and is operable to keep the mirror 450 and mirror base 452 from sliding off the stalk 410. The sacrificial layer 454 is etched away, as illustrated in FIG. 14, allowing the mirror 452 and mirror base 454 to vertically move between the substrate 456 and the cap 458. Also included in the substrate 456 is a capacitive plate 460, as illustrated in FIG. 15. Another capacitive plate may be included in the phase shift device 400. For example, a capacitive plate may be formed as part of the mirror base 452.

In operation, the capacitive plate 456 may be activated, causing a charge which alters the vertical position of the mirror 450 and the mirror base 452. The mirror 450 may move upward along the stalks 410 until being stopped by the caps 458. When the charge of the plate 546 is reduced, the mirror 450 and the mirror base 452 may move closer to the substrate 456. It is noted that, when the capacitive plate 456 is not activated, the vertical position of the mirror 450 and the mirror base 452 may vary depending on the orientation of the phase shift device 400 due to the effect of gravity. For example, if the device 400 is positioned so that the mirror 450 is “higher” than the substrate 458, then the mirror 450 and mirror base 452 may be located adjacent to the substrate 456 when the capacitive plate 460 is not activated.

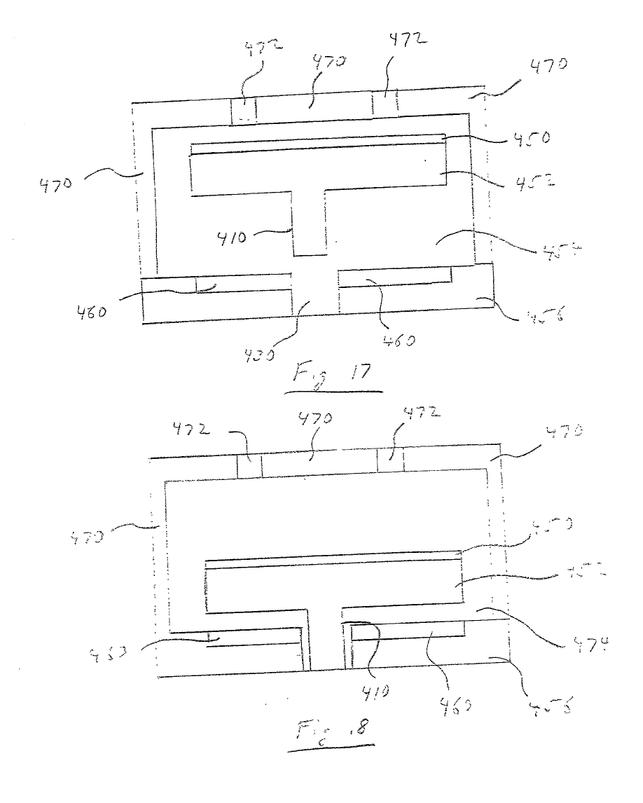

Referring now to FIGS. 17 and 18, another embodiment of the phase shift device 400 includes a mirror 450 housed in a shell 470. In the present embodiment, the shell 470 is cylindrical, although other shapes may be utilized. A portion of the shell 470, including the top (i.e., the portion adjacent to the surface of the mirror 450) may be formed of a transparent material such as SiO2. The shell 470 is attached to, or fabricated on, a substrate 456. One or more holes 472 may be present in the shell 470. The holes may be created using laser ablatement or some other means. The mirror 450 is on the upper surface of a mirror base 452. A stalk 410 is attached to the lower surface of the mirror base 452. The dimensions of the stalk 410 are such that the stalk 410 may fit inside a cavity 430 formed in the substrate 456. Although the present embodiment illustrates the stalk 410 as removable from the cavity 430, it is noted that the stalk 410 may be constructed with a length which will prevent removal of the entire stalk 410 from the cavity 430.

Also formed in, or attached to, the substrate 456 is a capacitive plate 460. In the present embodiment, the plate 460 is circular and forms a continuous ring around the edge of the cavity 430. In other embodiments, the plate 460 may be replaced by a plate having a different shape and/or a plurality of capacitive plates. A sacrificial layer 454 (illustrated in FIG. 17) may be utilized to aid in the fabrication of the device 400. The sacrificial layer is etched away to create a hollow interior 474 (illustrated in FIG. 18) for the shell 470.

In operation, the capacitive plate 460 may be activated by applying a voltage to the substrate 456. The degree of vertical movement of the mirror 450 and associated mirror base 452 may be controlled by varying the amount of voltage applied to the substrate 456.

In another embodiment, a paired hinge design is utilized in the phase shift device 400. Three sacrificial layers are etched away to leave a mirror with multiple hinges. Capacitive plates are positioned at each side of the hinges to enable vertical actuation of the mirror. In addition, by activating one side of the hinges, the mirror can be deflected at an angle so as to redirect the path of light reflected by the mirror. It is noted that different numbers of hinges (and, therefore, sacrificial layers and capacitive plates) may be utilized to achieve similar results.

In another embodiment, two capacitive strips are utilized to achieve deflection of the mirror. The strips, such as those in U.S. Pat. No. 5,311,360, are well known in the art. The present embodiment makes use of such capacitive strips, rather than light grating, for actuation. By having a micromachined mirror with a stalk attached in the center of each capacitive strip, the mirror can be vertically actuated to achieve phase shifting. Further, by selective individual activation of the capacitive strips, the angle of the mirror and, thus, the angle of reflected light can be altered. It is noted that different numbers of capacitive strips may be utilized to achieve similar results.

While the invention has been particularly shown and described with reference to the preferred embodiment thereof, it will be understood by those skilled in the art that various changes in form and detail may be made therein without departing from the spirit and scope of the invention. For example, it is within the scope of the present invention that alternate types and/or arrangements of membranes, mirrors, stalks, and/or other components may be used. Furthermore, the order of components may be altered in ways apparent to those skilled in the art. Additionally, the type and number of components may be supplemented, reduced or otherwise altered. Other uses are also foreseen, such as digital projection, optical-optical switching, Fabry-Perot interferometry, and phase shifting based inferometry. Therefore, the claims should be interpreted in a broad manner, consistent with the present invention.

What is claimed is:

1. An apparatus for adjustably reflecting light, the apparatus comprising:
a base;
a member positioned above the base, the member including an upper surface and a lower surface;
a reflective coating applied to at least a portion of the upper surface; and
a capacitive plate positioned between the member and the base;
wherein the capacitive plate is operable to deflect the member, the deflection altering an orientation of the member relative to the base.

2. The apparatus of claim 1 further including:
a second member positioned between the first member and the capacitive plate, the second member including an upper surface and a lower surface; and
a stalk positioned between the first and second members, the stalk connecting the first and second members;
wherein the capacitive plate is operable to deflect the second member, the deflection altering an orientation of the first member relative to the base.

3. The apparatus of claim 2 wherein at least one surface of the second member includes a conductive coating.

4. The apparatus of claim 3 wherein the second member is deformable, so that the capacitive plate is operable to deform the second member, the deformation altering the orientation of the first member relative to the base.

5. The apparatus of claim 2 further including:
a support connected to the base; and
at least one flexible arm connecting the support and the stalk;
wherein the arm is operable to at least partially control the direction of deflection.

6. The apparatus of claim 1 further including:
a second capacitive plate positioned on the lower surface of the member;
wherein the first and second capacitive plates are operable to deflect the member.

7. The apparatus of claim 1 further including a cavity formed in the base, wherein at least a portion of the capacitive plate is located within the cavity.

8. The apparatus of claim 7 further including:
a lip formed around the edge of the cavity; and
a stalk connected to the lower surface of the member;
wherein at least a portion of the stalk is operable to fit into the cavity and partially guide the deflection of the member.

9. The apparatus of claim 1 further including a shell to protect the member.

10. The apparatus of claim 9 wherein at least a portion of the shell is transparent so that light can interact with the reflective surface of the member.

11. The apparatus of claim 1 further including a plurality of capacitive plates positioned between the member and the base, wherein the capacitive plates are selectively operable to deflect the member relative to the base, the direction of deflection controllable by the selective operation of the capacitive plates.

12. The apparatus of claim 11 wherein the capacitive plates are positioned in a plane substantially parallel to the base.

13. An apparatus for adjustably reflecting light, the apparatus comprising:
a base;
a reflective layer positioned above the base; and
a stalk penetrating the reflective layer;
wherein the reflective layer may be deflected by applying a voltage to the base, the direction of the deflection controlled by the stalk.

14. The apparatus of claim 13 wherein the stalk further includes a cap on the end opposite the base, the cap operable to prevent the mirror layer from moving off the stalk.

15. The apparatus of claim 13 further including a capacitive plate positioned between the reflective layer and the base.

16. A method for adjustably reflecting light, the method including:
providing a base;
providing a reflective member;
providing a conductive member attached to the reflective member;
projecting light onto the reflective member;
providing a voltage to produce charge repulsion between the base and the conductive member; and
altering the position of the conductive member through the charge repulsion;
wherein the orientation of the reflective member relative to the base is adjustably altered to reflect the light.

17. The method of claim 16 wherein the reflective member and the conductive member are the same member.

18. The method of claim 16 further including:
sensing wavefront information embodying a subject; and
adjusting the position of the conductive member in response to the information;
wherein the orientation of the reflective member is adjustably altered to reflect the light in response to the information.

19. The method of claim 16 further including providing a plurality of capacitive plates, the plurality of capacitive plates enabling additional adjustability in the orientation of the reflective member.

20. The method of claim 18 further including magnifying the altered orientation of the reflective member using a lens system, wherein relatively small alterations in the orientation of the reflective member are magnified when reflected.
